(19) United States
(12) Patent Application Publication
(10) Pub. No.: US 2025/0266518 A1
(43) Pub. Date: Aug. 21, 2025

(54) CELL CONFIGURED FOR PENETRATION TEST

(71) Applicant: SAMSUNG SDI CO., LTD., Yongin-si (KR)

(72) Inventor: Min Hyung GUEN, Yongin-si (KR)

(21) Appl. No.: 18/788,392

(22) Filed: Jul. 30, 2024

(30) Foreign Application Priority Data
Feb. 15, 2024 (KR) 10-2024-0021507

(51) Int. Cl. H01M 10/48; H01M 50/103; H01M 50/121; H01M 50/133; H01M 50/14

(52) U.S. Cl. CPC H01M 10/48; H01M 50/103; H01M 50/121; H01M 50/133; H01M 50/14

(57) ABSTRACT

A cell is configured for a penetration test such that the cell is not damaged when a hole for the penetration test is formed. The cell includes an electrode assembly, a case accommodating the electrode assembly and having an area in which a hole for the penetration test is formed, and a protective sheet disposed at a position corresponding to the area between the electrode assembly and the case.

### BACKGROUND

This application claims priority to and the benefit of Korean Patent Application No. 10-2024-0021507 filed in the Korean Intellectual Property Office on Feb. 15, 2024, the entire contents of which are incorporated herein by reference.

### 1. FIELD

Embodiments of the present disclosure relate to a cell configured for a penetration test.

### 2. DESCRIPTION OF THE RELATED ART

Lithium-ion secondary batteries are used as power sources for hybrid or electric vehicles as well as portable electronic devices because of their advantages of a high operating voltage and a high energy density per unit weight. Such secondary batteries may be classified as cylindrical, prismatic, and pouch-type secondary batteries depending on their shape.

If a secondary battery is deformed due to an external impact, and especially if it is penetrated, it has to undergo a penetration test according to predetermined standards to ensure safety. The penetration test is often performed by forming a penetration test hole in a cell case or can and then inserting a penetration test pin into the penetration test hole. However, the cell may be damaged during the process of forming the hole for the penetration test. A solution for this problem would be beneficial.

The above-described information regarding technology is only intended to enhance understanding of the background of the present disclosure and may include information that does not constitute related art.

### SUMMARY

Aspects of some embodiments of the present disclosure provide a cell configured for a penetration test, which does not become damaged when a hole is formed in the cell for a penetration test.

According to some embodiments, a cell configured for a penetration test includes: an electrode assembly; a case accommodating the electrode assembly and having an area in which a hole for the penetration test is formed; and a protective sheet disposed at a position corresponding to the area and positioned between the electrode assembly and the case.

A part of the protective sheet extends along at least a portion of an edge of the area and an opening is formed in the protective sheet such that a pin for the penetration test can pass therethrough the protective sheet.

The protective sheet may be an annular shaped.

The protective sheet may have an outer diameter that is greater than a diameter of the area.

The protective sheet may have an inner diameter that is less than a diameter of the area.

The protective sheet may be configured to cover an edge of the area.

The protective sheet may be made of an insulating material that does not chemically react with an electrolyte accommodated in the case.

The protective sheet may be made of one or more of polypropylene (PP), polyethylene (PE), ethylene-propylene-diene monomer (EPDM), ethylene propylene rubber (EPR), polytetrafluoroethylene (PTFE), polyphenylene sulfide (PPS), polyether ether ketone (PEEK), polyacetal, nylon.

The protective sheet may have a thickness that is equal to or less than a gap between the electrode assembly and the case.

The protective sheet may have a thickness of about 0.1 mm to about 0.2 mm.

The protective sheet may be attached to the electrode assembly.

The protective sheet may be attached to the case.

The protective sheet may be attached to both of the electrode assembly and the case.

A groove is formed in case and the protective sheet is accommodated in the groove.

The protective sheet may be attached to the groove.

The protective sheet may have a thickness that is equal to or less than a depth of the groove.

The area may have a diameter of about 8 mm to about 12 mm.

The case may be hexahedral shaped.

The area may be disposed at a center of a side surface of the case.

The cell may further include: a cap plate coupled to the case; and a terminal disposed on the cap plate and electrically connected to the electrode assembly.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain principles of the present disclosure. In the drawings:

FIG. 1 illustrates a perspective view of a cell for a penetration test according to embodiments;

FIG. 2 illustrates a cross-sectional view taken along line II-II′ of FIG. 1;

FIG. 3 illustrates a cross-sectional view taken along line III-III of FIG. 1;

FIG. 4 illustrates a perspective view of a protective sheet of the cell for the penetration test according to embodiments; and

FIG. 5 illustrates a cross-sectional view of a cell for a penetration test according to other embodiments.

### DETAILED DESCRIPTION

Hereinafter, embodiments will be described in detail with reference to the accompanying drawings.

The present disclosure may, however, be embodied in many different forms and should not be construed as being limited to the embodiments set forth herein. Rather, these embodiments are provided so that those skilled in the art thoroughly understand the present disclosure. In other words, these embodiments are provided so that this disclosure will be thorough and complete and will fully convey the scope of the present disclosure to those skilled in the art.

In addition, in the following drawings, the thickness or size of each layer is exaggerated for convenience and clarity of description, and the same reference numerals in the drawings refer to the same elements. As used herein, the term “and/or” includes any and all combinations of one or more of the associated listed items. In this specification, it will also be understood that if a member A is referred to as being connected to a member B, the member A may be directly connected to the member B or indirectly connected to the member B with a member B therebetween.

The terms used in this specification are for illustrative purposes of the present disclosure only and should not be construed to limit the meaning or the scope of the present disclosure. As used in this specification, a singular form may, unless definitely indicating a particular case in terms of the context, include a plural form. Also, the expressions “comprise” and/or “comprising” used in this specification neither define the mentioned shapes, numbers, steps, operations, members, elements, and/or groups of these, nor exclude the presence or addition of one or more other different shapes, numbers, steps, operations, members, elements, and/or groups of these, or addition of these. The term “and/or” used herein includes any and all combinations of one or more of the associated listed items.

As used herein, terms such as “first,” “second,” etc. are used to describe various members, components, areas, layers, and/or portions. However, it will be obvious that the members, components, areas, layers, and/or portions should not be defined by these terms. The terms do not mean a particular order, up and down, or superiority, and are used only for distinguishing one member, component, region, layer, or portion from another member, component, region, layer, or portion. Thus, a first member, component, area, layer, or portion which will be described may also refer to a second member, component, area, layer, or portion, without departing from the teaching of the present disclosure.

Spatially relative terms, such as “below”, “beneath”, “lower”, “above”, “upper” and the like, may be used herein for ease of description to describe one element or feature's relationship to another element(s) or feature(s) as illustrated in the figures. These spatially relative terms are intended for easy comprehension of the prevent disclosure according to various process states or usage states of the prevent disclosure, and, thus, the present disclosure is not limited thereto. For example, an element or feature shown in the drawings is turned inside out, the element or feature described as “beneath” or “below” may change into “above” or “upper”. Thus, the term “lower” may encompass the term “upper” or “below”.

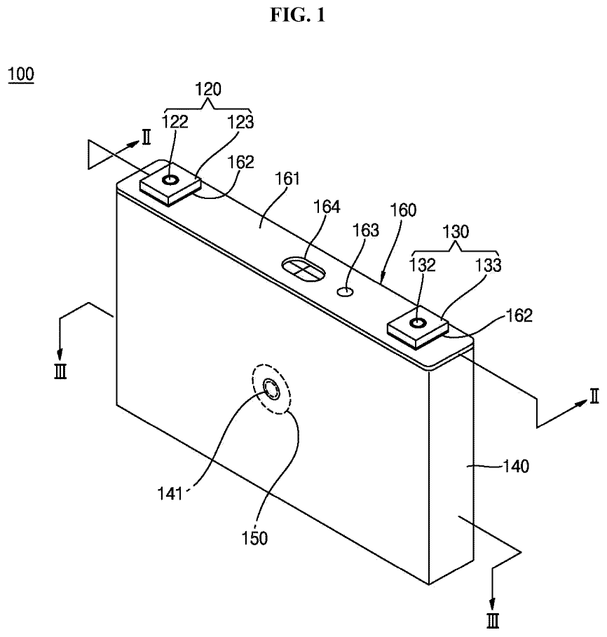

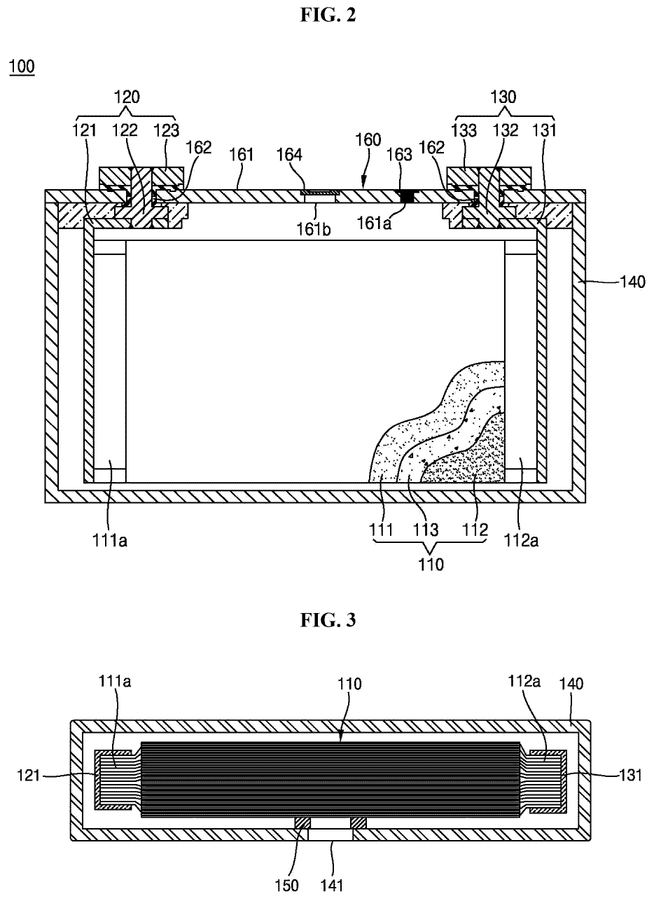

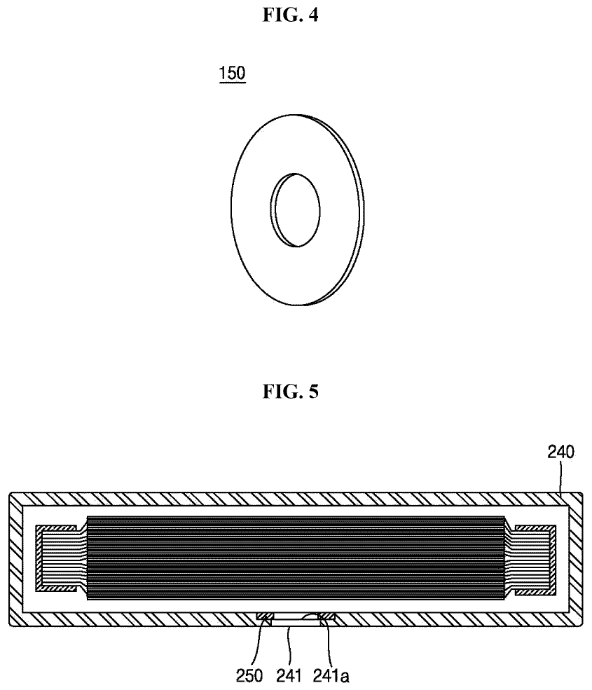

FIG. 1 illustrates a perspective view of a cell for a penetration test according to embodiments, FIG. 2 illustrates a cross-sectional view taken along line II-II′ of FIG. 1, and FIG. 3 illustrates a cross-sectional view taken along line III-III of FIG. 1. FIG. 4 illustrates a perspective view of a protective sheet of the cell for the penetration test according to embodiments.

Referring to FIGS. 1 to 3, a cell 100 for a penetration test according to embodiments may include an electrode assembly 110, a first terminal 120, a second terminal 130, a case 140, a protective sheet 150, and a cap assembly 160.

The electrode assembly 110 may be provided by winding or stacking a first electrode plate 111, a separator 113, a second electrode plate 112, and the like, each of which is provided in a thin plate shape or film shape. The latter case will be illustrated in the drawing.

The first electrode plate 111 may serve as a negative electrode, and the second electrode plate 112 may serve as a positive electrode, and vice versa.

The first electrode plate 111 may be formed by applying a first electrode active material, such as graphite or carbon, to a first electrode base material made of metal foil, such as copper, a copper alloy, nickel, or a nickel alloy. The first electrode plate may include a first electrode non-coating portion 111a that is not coated with the first electrode active material. The first electrode non-coating portion 111a may serve as a path for a current flow between the first electrode plate 111 and the first terminal 120.

The second electrode plate 112 may be formed by applying a second electrode active material, such as transition metal oxide, to a second electrode base material made of metal foil, such as aluminum or an aluminum alloy. The second electrode plate 112 may include a second electrode non-coating portion 112a that is not coated with the second electrode active material. The second electrode non-coating portion 112a may serve as a path for a current flow between the second electrode plate 112 and the second terminal 130.

The first electrode non-coating portion 111a may protrude to one side of the electrode assembly 110 and the second electrode non-coating portion 112a may protrude to the other side of the electrode assembly 110.

The separator 113 may be disposed between the first electrode 111 and the second electrode 112 to prevent a short circuit and allow movement of lithium ions. The separator 113 may be made of polyethylene, polypropylene, or a composite film of polyethylene and polypropylene.

The electrode assembly 110 may be accommodated in the case 140 together with an electrolyte. The electrolyte may include an organic solvent such as ethylene carbonate (EC), propylene carbonate (PC), diethyl carbonate (DEC), ethyl methyl carbonate (EMC), and/or dimethyl carbonate (DMC), and lithium salt such as lithium hexafluorophosphate (LiPF6) and/or lithium tetrafluoroborate (LiBF4).

The first terminal 120 may be made of a metal and may be electrically connected to the first electrode plate 111.

The first terminal 120 may include a first current collector plate 121, a first terminal pillar 122, and a first terminal plate 123.

The first current collector plate 121 may be welded to the first electrode non-coating portion 111a protruding from one end of the electrode assembly 110. The first current collector plate 121 may be provided in as shaped in the drawing and define a hole in an upper portion thereof, and the first terminal pillar 122 may be inserted into the hole and riveted and/or welded. A portion extending downward from the first current collector plate 121 may be provided to surround the first electrode non-coating portion 111a. The first current collector plate 121 may be made of copper or a copper alloy.

The first terminal pillar 122 may extend and protrude upward through the cap plate 161 and may be electrically connected to the first current collector plate 121 below the cap plate 161. In some embodiments, the first terminal pillar 122 may have a flange provided below the cap plate 161 to prevent the first terminal pillar 122 from being separated from the cap plate 161. The portion disposed below the flange of the first terminal pillar 122 may be inserted into the hole of the first current collector plate 121 and then riveted and/or welded, as described above. The first current collector plate 122 may be made of copper, a copper alloy, aluminum, or an aluminum alloy. The first terminal pillar 122 may be electrically insulated from the cap plate 161.

A hole may be defined in the first terminal plate 123, and an upper portion of the first terminal pillar 122 may be inserted into the hole and then riveted and/or welded. The first terminal plate 123 may be electrically insulated from the cap plate 161.

The second terminal 130 may also be made of a metal and may be electrically connected to the second electrode plate 112.

The second terminal 130 may include a second current collector plate 131, a second terminal pillar 132, and a second terminal plate 133. The second current collector plate 131 may be welded to the second electrode non-coating portion 112a protruding from the other end of the electrode assembly 110. The second current collector plate 131 may be provided in the shape shown in the drawing and define a hole defined in the upper portion thereof, and the second terminal pillar 132 may be inserted into the hole and riveted and/or welded. A portion extending downward from the second current collector plate 131 may be provided to surround the second electrode non-coating portion 112a. The second current collector plate 131 may be made of aluminum or an aluminum alloy.

The second terminal pillar 132 may extend and protrude upward through the cap plate 161 and may be electrically connected to the second current collector plate 131 below the cap plate 161. In some embodiments, the second terminal pillar 132 may have a flange provided below the cap plate 161 to prevent the second terminal pillar 132 from being separated from the cap plate 161. The portion disposed below the flange of the second terminal pillar 132 may be inserted into the hole of the second current collector plate 131 and then riveted and/or welded, as described above. The second terminal pillar 132 may be made of aluminum or an aluminum alloy. The second terminal pillar 132 may be electrically insulated from the cap plate 161.

A hole may be defined in the second terminal plate 133, and the upper portion of the second terminal pillar 132 may be inserted into the hole and then riveted and/or welded. The second terminal plate 133 may be electrically insulated from the cap plate 161.

The case 140 may be made of a metal such as aluminum, an aluminum alloy, or nickel-plated steel and may be provided in a substantially hexahedral shape with an opening through which the electrode assembly 110 is inserted. The opening of the case 140 may be sealed by coupling the cap plate 161.

The case 140 may have a hole in one surface into which a pin for the penetration test will be inserted, that is, an area 141 in which the hole for the penetration test is formed. In the drawing, the area 141 may be illustrated as being disposed at an approximately center thereof on a relatively wide side surface of the case 140. The area 141 may have a diameter of about 8 mm to about 12 mm.

The hole for the penetration test may be formed by cutting and removing the area 141 from the outside, for example, using a rotary cutting blade. The pin for the penetration test may be inserted into the electrode assembly 110 through the penetration hole to test safety during the penetration.

However, in the process of processing the hole for the penetration test, a sharp burr may be generated toward the inside of the case 140, and as the cutting blade is pressed against one surface of the case 140 to process the hole for the penetration test, the electrode assembly may be damaged by the burr. Therefore, an ignition may occur unintentionally during the penetration test. Also, there may also be a problem in that results of the penetration test are affected by depth changes in the corresponding portion, which may reduce the accuracy of the test.

To prevent the above-described problems, the cell 100 for the penetration test 100 according to embodiments may include a protective sheet 150.

The protective sheet 150 may be disposed between the electrode assembly 110 and the case 140 at a position corresponding to the area 141 where the penetration hole is formed.

In some embodiments, the protective sheet 150 may include an area extending along at least a portion of an edge of the area 141 and may have an opening therein so that the pin for the penetration test can pass therethrough. For example, the protective sheet 150 may be provided in an annular shape as illustrated in FIG. 4 such that an outer diameter thereof is greater than a diameter of the area 141 and an inner diameter thereof is less than the diameter of the area 141.

Thus, even if the sharp burr is generated toward the inside of the case 140 in the process of forming the hole of the penetration test, by covering the edge of the area 141 with respect to the electrode assembly 110, the electrode assembly 110 may be prevented from being damaged. In some embodiments, even if the cutting blade is disposed on one surface of the case 140 to apply a predetermined pressure so as to form the hole for the penetration test, the electrode assembly 110 may be prevented from being damaged by being the cushioning provided by the protective sheet 150.

The protective sheet 150 may be an insulating material that does not chemically react with the electrolyte and may be made of a material with appropriate physical properties (rigidity, hardness, brittleness, etc.) to protect the electrode assembly 110. For example, the protective sheet 150 may be made of polypropylene (PP), polyethylene (PE), ethylene-propylene-diene monomer (EPDM), ethylene propylene rubber (EPR), polytetrafluoroethylene (PTFE), polyphenylene sulfide (PPS), polyether ether ketone (PEEK), polyacetal, nylon, or a combination of one or more of these materials.

A thickness of the protective sheet 150 is not particularly limited as long as it is equal to or less than a gap that exists between the electrode assembly 110 and the case 140 when the cell 100 is assembled. However, according to some embodiment, to effectively protect the electrode assembly 110 while securing sufficient battery capacity, the protective sheet 150 may be provided with a thickness of about 0.1 mm to about 0.2 mm.

The protective sheet 150 may be attached to the electrode assembly 110 and/or the case 140. In some embodiments, the protective sheet 150 may be attached to an outer surface of the electrode assembly 110 and/or an inner surface of the case 140. In some embodiments where the protective sheet 150 is attached to the inner surface of the case 140, because there is possibility that an end of the electrode assembly 110 is hung on the protective sheet 150 to thereby cause deformation of the electrode assembly 110 or the protective sheet 150 as the electrode assembly 110 is inserted into the case 140 during assembly, it may be advantageous for the protective sheet 150 to be attached to the outer surface of the electrode assembly 110. In some embodiments, the protective sheet 150 may be attached to both of the outer surface of the electrode assembly 110 and the inner surface of the case 140.

The cap assembly 160 may be coupled to the case 140. The cap assembly 160 may include a cap plate 161, a gasket 162, a stopper 163, and a safety vent 164. The cap plate 161 may be welded to seal the opening of the case 140.

Gaskets 162 may be disposed between the first terminal 120 and the cap plate 161 and between the second terminal 130 and the cap plate 161 to electrically insulate the first terminal 120 from the cap plate 161 and electrically insulate the second terminal 130 from the cap plate 161. The gaskets 162 may also prevent moisture or foreign substances permeating into the case and prevent the electrolyte from leaking out of the case 140.

The stopper 163 may seal an electrolyte injection port 161a of the cap plate 161, and the safety vent 164 may be installed in a vent hole 161b of the cap plate 161. The safety vent 164 may be provided with a notch so as to open at a set pressure.

Based on the configuration described above, the following will describe a method of forming the hole for the penetration test in the cell 100 configured for the penetration test according to embodiments.

First, the cell 100 for the penetration test may be prepared, and the area 141 may be cut and removed from the case 140 by using, for example, a rotary cutting blade. In this process, a sharp burr may be generated toward the inside of the case 140, and there may be a problem in that the electrode assembly can be damaged if the cutting blade is pressed against one surface of the case 140. However, the cell 100 configured for the penetration test according to embodiments protects the electrode assembly 110 by using the protective sheet 150 to prevent the electrode assembly 110 from being damaged, thereby improving accuracy of the cell penetration test.

In some embodiments, the area 141 may be cut only to a depth corresponding to the thickness of the case 140, but even if the cutting blade is inserted further beyond the thickness of the case 140, the electrode assembly may be prevented from being directly damaged by the cutting blade due to the protective sheet 150.

FIG. 5 illustrates a cross-sectional view of a cell configured for a penetration test according to other embodiments and illustrates a configuration corresponding to that of FIG. 3.

A cell configured for a penetration test according to other embodiments may include an electrode assembly, a first terminal, a second terminal, a case 240, a protective sheet 250, and a cap assembly.

However, the electrode assembly, the first terminal, the second terminal, and the cap assembly of the cell configured for the penetration test according to other embodiments may be substantially the same with respect to the electrode assembly 110, the first terminal 120, the second terminal 130, and the cap assembly 160 of the cell 100 for the penetration test according to embodiments. Thus, duplicate descriptions will be omitted. A case 240 and a protective sheet 250 will be described below in detail.

The case 240 may be made of a metal, such as aluminum, an aluminum alloy, or nickel-plated steel, and may be provided in a substantially hexahedral shape with an opening through which the electrode assembly is inserted. The opening of the case 240 may be sealed by coupling the cap plate.

The case 240 may have a hole formed in one surface into which a pin for the penetration test will be inserted. That is, an area 241 of the hole for the penetration test is formed in the case 240. In some embodiments, a hole for the penetration test may be defined by cutting the area 241 from outside of the case 240, for example, using a rotary cutter. Therefore, safety may be tested by inserting the pin for the penetration test into the electrode assembly through the hole for the penetration test.

As compared to the case 140 of the cell 100 for the penetration test according to the embodiments described above, the case 240 of the cell 100 for the penetration test according to other embodiments is different in that a groove 241a is defined at a portion corresponding to the protective sheet 250 in an inner surface, and the protective sheet 250 is accommodated in the groove 241.

The protective sheet 250 may be disposed between the electrode assembly and the case 240 at a position corresponding to the area 241.

In some embodiments, the protective sheet 250 may include an area extending along at least a portion of an edge of the area 241, and an opening may be formed in the protective sheet 250 so that the pin for the penetration test can pass therethrough. The protective sheet 250 may be provided, for example, in an annular shape so that an outer diameter thereof is greater than a diameter of the area 241 and an inner diameter thereof is less than that the diameter of the area 241.

The protective sheet 250 may be an insulating material that does not chemically react with the electrolyte and may be made of a material with appropriate physical properties (rigidity, hardness, brittleness, etc.) to protect the electrode assembly. For example, the protective sheet 250 may be made of PP, PE, EPDM, EPR, PTFE, PPS, PEEK, polyacetal, nylon, or a combination of at least some thereof.

This protective sheet 250 may be accommodated in the groove 241a of the case 240. In some embodiments, the protective sheet 250 may be attached to the groove 241a of the case 240. Therefore, the protective sheet 250 may be seated more stably within the cell configured for the penetration test.

In some embodiments, a thickness of the protective sheet 250 may be equal to or less than a depth of the groove 241a. Therefore, if the protective sheet 250 is accommodated in the groove 241a, the protective sheet 250 does not protrude from an inner surface of the case 240. In the drawing, thickness of the protective sheet 250 is illustrated as being equal to the depth of the groove 241a.

As described above, if the protective sheet 150 is attached to the inner surface of the case 140 in the cell 100 the end of the electrode assembly 110 may hang on the protective sheet 150 and thereby deform the electrode assembly 110 or the protective sheet 150 as the electrode assembly 110 is inserted into the case 140 during the assembly. However, as described above, the groove 241a may be formed in the case 240, and the protective sheet 250 may be accommodated in the groove 241a so as not to protrude from the inner surface of the case 240. Thus, there is no interference with the protective sheet when the electrode assembly is inserted into the case 140.

The disclosures above are merely embodiments of the cell configured for the penetration test, and the present disclosure is not limited to the foregoing embodiments. It will be understood by those of ordinary skill in the art that various changes in form and details may be made without departing from the spirit and scope of the present disclosure.

For example, in this disclosure, the cell may be illustrated a so-called prismatic battery, and it has been explained that the first and second electrode non-coating portions protrude to the sides of the electrode assembly, respectively, the first and second terminals include the first and second current collectors provided in the shapes shown in the drawings, the first and second terminal pillars are riveted and/or welded, first and second terminal plates are provided, the case is hexahedral shaped, the cap assembly includes the cap plate on which the first and second terminal plates are disposed, and gaskets, a stopper, and a safety vent are provided. However, such a configuration is merely an example of one of various types of cells to which the technical ideas of the present disclosure may be applied.

Embodiments may provide a cell configured for a penetration test, which is capable of protecting an electrode assembly by providing the protective sheet between the electrode assembly and the case which protects the electrode assembly when the hole for the penetration test is formed.

In addition, if the protective sheet is attached to the case, a groove may be defined in the case, and the protective sheet may be accommodated in the groove so as not to protrude from the inner surface of the case. Thus, the protective sheet may not interfere with the electrode assembly when the electrode assembly is inserted during the assembly of the cell.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present disclosure.

What is claimed is:

1. A cell configured for a penetration test, the cell comprising:
an electrode assembly;
a case accommodating the electrode assembly and having an area in which a hole for the penetration test is formed; and
a protective sheet disposed at a position corresponding to the area and positioned between the electrode assembly and the case.

2. The cell as claimed as claim 1, wherein part of the protective sheet extends along at least a portion of an edge of the area, and an opening is formed in the protective sheet such that a pin for the penetration test can pass through protective sheet.

3. The cell as claimed as claim 1, wherein the protective sheet is annular shape.

4. The cell as claimed as claim 3, wherein the protective sheet has an outer diameter that is greater than a diameter of the area.

5. The cell as claimed as claim 3, wherein the protective sheet has an inner diameter that is less than the diameter of the area.

6. The cell as claimed as claim 1, wherein the protective sheet is configured to cover an edge of the area.

7. The cell as claimed as claim 1, wherein the protective sheet is made of an insulating material that does not chemically react with an electrolyte accommodated in the case.

8. The cell as claimed as claim 1, wherein the protective sheet is made of one or more of polypropylene (PP), polyethylene (PE), ethylene-propylene-diene monomer (EPDM), ethylene propylene rubber (EPR), polytetrafluoroethylene (PTFE), polyphenylene sulfide (PPS), polyether ether ketone (PEEK), polyacetal, and nylon.

9. The cell as claimed as claim 1, wherein the protective sheet has a thickness that is equal to or less than a gap between the electrode assembly and the case.

10. The cell as claimed as claim 1, wherein the protective sheet has a thickness of about 0.1 mm to about 0.2 mm.

11. The cell as claimed as claim 1, wherein the protective sheet is attached to the electrode assembly.

12. The cell as claimed as claim 1, wherein the protective sheet is attached to the case.

13. The cell as claimed as claim 1, wherein the protective sheet is attached to both of the electrode assembly and the case.

14. The cell as claimed as claim 1, wherein a groove is formed in the case and the protective sheet is accommodated in the groove.

15. The cell as claimed as claim 14, wherein the protective sheet is attached to the groove.

16. The cell as claimed as claim 14, wherein the protective sheet has a thickness that is equal to or less than a depth of the groove.

17. The cell as claimed as claim 1, wherein the area has a diameter of about 8 mm to about 12 mm.

18. The cell as claimed as claim 1, wherein the case is hexahedral shaped.

19. The cell as claimed as claim 18, wherein the area is disposed at a center of a side surface of the case.

20. The cell as claimed as claim 18, further comprising:
a cap plate coupled to the case; and
a terminal disposed on the cap plate and electrically connected to the electrode assembly.
